(19) United States
(12) Patent Application Publication
(10) Pub. No.: US 2020/0370883 A1
(43) Pub. Date: Nov. 26, 2020

(54) SHEET DISTINCTION DEVICE AND IMAGE FORMING APPARATUS

(71) Applicant: Konica Minolta, Inc., Tokyo (JP)

(72) Inventors: Satoshi OGATA, Tokyo (JP); Kazutoshi YOSHIMURA, Tokyo (JP); Yumiko IZUMIYA, Tokyo (JP)

(21) Appl. No.: 16/878,986

(22) Filed: May 20, 2020

(30) Foreign Application Priority Data
May 20, 2019 (JP) 2019-094258

(51) Int. Cl. G01B 11/30; G03G 15/00

(52) U.S. Cl. CPC G01B 11/30; G03G 15/5062

(57) ABSTRACT

A sheet distinction device includes a measurer, a housing, a shutter, a calibration plate, and a controller. The measurer emits light to a sheet, receives light reflected from the sheet, and acquires detection information for determining physical properties of the sheet. The housing houses the measurer and is provided with an opening through which the emitted light and the reflected light pass. The shutter switches between a closed state in which the opening is closed and an open state in which the opening is open. The calibration plate is provided on a surface of the shutter which is on an inner side in the closed state. In the closed state, the measurer emits light to a calibration plate and receives reflected light to acquire acquisition information. The controller calibrates the measurer based on the acquisition information.

### CROSS REFERENCE TO RELATED APPLICATIONS

The present invention claims priority under 35 U.S.C. § 119 to Japanese Application No. 2019-094258 filed May 20, 2019, the entire content of which is incorporated herein by reference.

### BACKGROUND

### 1. Technological Field

The present invention relates to a sheet distinction device and an image forming apparatus.

### 2. Description of the Related Art

A known sheet distinction device determines a type of a sheet used in imaging. The sheet distinction device comprises a light emitter and a light receiver in a case in which an opening is formed. The light emitter emits light to a sheet through the opening. The light receiver receives light reflected from the sheet through the opening. The type of the sheet is determined from obtained optical information.

As such a sheet distinction device, known devices are provided with a calibration plate to prevent deterioration of distinction performance due to aging or the like. For example, according to JP 2015-215338A, a calibration plate is disposed outside a case so as to face an opening. A movable shutter is provided between the case and the calibration plate. The shutter switches between a state in which light can be emitted to the calibration plate and a state in which light cannot be emitted to the calibration plate.

According to the sheet distinction device in JP 2015-215338A, the opening is always open. In a case in which the device is installed in an image forming apparatus, a substantial number of sheets are conveyed. Dust generated from sheets enters the case through the opening. It degrades the sheet distinction device and reduces distinction performance. Conveyance condition of sheets also becomes considerably worse. It causes a jam in the opening.

It has been studied to provide a movable shutter for opening and closing the opening. A calibration plate is placed on an inner surface of the shutter (inside the case). However, since the shutter is movable, each time the shutter is opened and closed, the calibration plate changes its position and angle. It sometimes results in an error in calibration.

### SUMMARY

An object of the present invention is to provide a sheet distinction device and an image forming apparatus that maintain a high-precision paper distinction performance by constantly and appropriately performing calibration while reducing effect of dust.

To achieve at least one of the abovementioned objects, according to an aspect of the present invention, a sheet distinction device includes:
a measurer that emits light to a sheet, receives light reflected from the sheet, and acquires detection information for determining physical properties of the sheet;
a housing that houses the measurer and is provided with an opening through which the emitted light and the reflected light pass;
a shutter that switches between a closed state in which the opening is closed and an open state in which the opening is open;
a calibration plate provided on a surface of the shutter which is on an inner side in the closed state;
an open-close mechanism that opens and closes the shutter; and
a controller that controls the open-close mechanism to make the shutter perform open-close operation in which the shutter switches between the open state and the closed state continuously,
wherein
in the closed state during the open-close operation, the controller makes the measurer emit light to a calibration plate and receive reflected light to acquire acquisition information, and
the controller calibrates the measurer based on the acquisition information.

According to another aspect of the present invention, an image forming apparatus includes the sheet distinction device.

The present invention maintains high-precision paper distinction performance by constantly and appropriately performing calibration while reducing effect of dust.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram showing an image forming apparatus.

FIG. 2 is a block diagram showing a functional configuration of the image forming apparatus.

FIG. 3 is a schematic diagram showing a sheet distinguisher.

FIG. 4 is a schematic perspective view showing the sheet distinguisher.

FIG. 5 is a cross-sectional view of the sheet distinguisher along V-V line in FIG. 4.

FIG. 6 describes configuration of a shutter.

FIG. 7 is a flowchart showing a flow of image forming processing.

FIG. 8 is a flowchart showing a flow of calibration information acquisition processing.

FIG. 9 shows fluctuations in a detected value.

### DETAILED DESCRIPTION OF EMBODIMENTS

Hereinafter, one or more embodiments of the present invention will be described with reference to the drawings. However, the scope of the invention is not limited to examples shown in the drawings.

### Image Forming Apparatus

First, an image forming apparatus 1 according to an embodiment will be described.

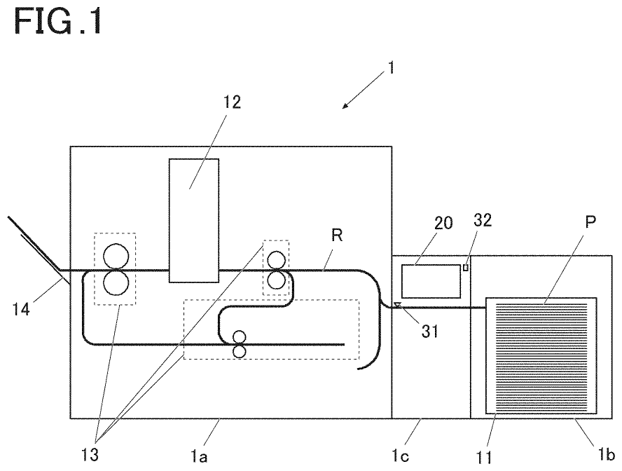

FIG. 1 is a schematic diagram showing the entire configuration of the image forming apparatus 1.

The image forming apparatus 1 puts a colorant on a sheet P to form images.

Toner is adhered to and fixed to paper, for example, in an electrophotographic method.

As shown in FIG. 1, the image forming apparatus 1 includes, for example, a sheet supplier 11, an image drawer 12, a conveyor 13, an ejection tray 14, and a sheet distinguisher 20.

The sheet supplier 11 includes a tray and holds sheets P on which an image is to be formed. The sheet supplier 11 sends a sheet P to a conveyance route R at an appropriate time.

According to the example in FIG. 1, the sheet supplier 11 is provided in a sheet supplier 1b provided on a side of a main body 1a of the image forming apparatus 1. However, the sheet supplier 11 can be disposed at any place as long as the sheet supplier 11 can hold sheets P and send them to the conveyance route R.

The image drawer 12 includes an image forming engine (print engine) that forms an image on a sheet P by putting and fixing a colorant such as toner or ink to the sheet P. The composition and type of the image drawer 12 are not limited. For example, a toner image of CMYK four colors or the like is formed (developed) on a photosensitive member in an electrophotographic method. The toner image on the photosensitive member is transferred to a sheet P directly or through a transfer member. Thus, a color image is formed.

The conveyor 13 includes a roller that holds and moves a sheet P and a rotary motor that rotates the roller. The conveyor 13 moves a sheet P along the conveyance route R at a predetermined speed. The conveyor 13 further includes a reverser. The reverser reverses front and back sides of a sheet P, on one side of which an image has been formed, to form an image again.

A sheet P on which an image has been formed by the image drawer 12 is ejected to the ejection tray 14.

The sheet distinguisher 20 emits light to a sheet P and determines the type of the sheet P from optical information (detection information), such as an amount of light reflected from the sheet P.

A sheet P is, for example, paper or a resin plate. Paper may be rough paper having a surface of coarse paper fiber, plain paper commonly used, high-quality paper having a surface with fine roughness, coated paper having a surface covered with a coating layer, or the like. Sheets are different in surface condition (surface smoothness), thickness, basis weight, etc. Optical information obtained from sheets vary, and is used to determine the type of a sheet P.

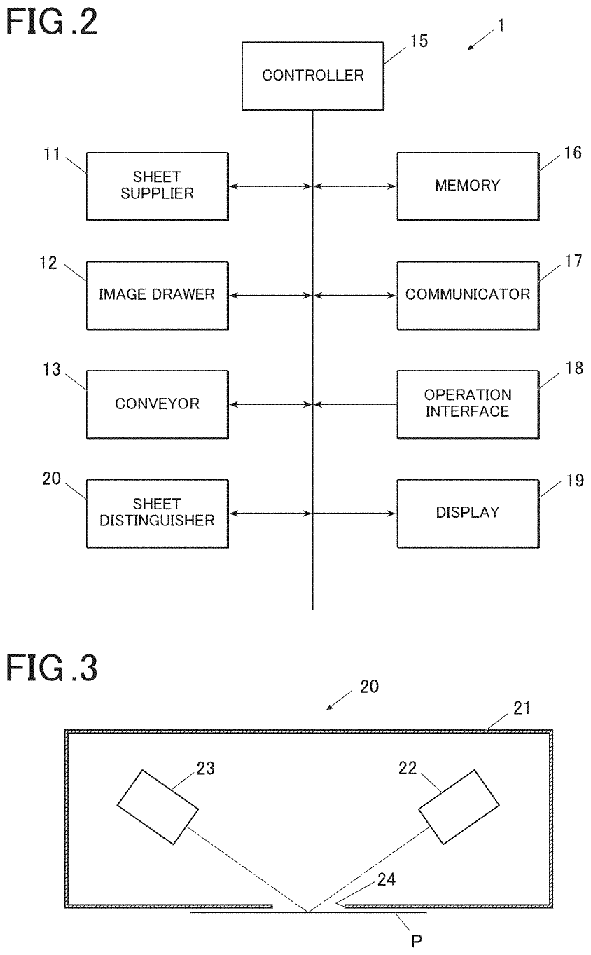

The sheet distinguisher 20 and a controller 15 (see FIG. 2) constitute a sheet distinction device. Details of the sheet distinguisher 20 will be described later.

According to the example in FIG. 1, the sheet distinguisher 20 is provided in an intermediate unit 1c between the main body 1a and the sheet supplier 1b of the image forming apparatus 1. However, position of the sheet distinguisher 20 is not limited thereto.

FIG. 2 is a block diagram showing a functional configuration of the image forming apparatus 1.

As shown in FIG. 2, the image forming apparatus 1 includes the controller 15, a memory 16, a communicator 17, an operation interface 18, and a display 19 in addition to the sheet supplier 11, the image drawer 12, the conveyor 13, and the sheet distinguisher 20.

The controller 15 supervises and controls various operations of the image forming apparatus 1. The controller 15 includes a CPU (Central Processing Unit) and a RAM (Random Access Memory).

The controller 15 reads control programs stored in the memory 16. The CPU executes the control program. Thus, the controller 15 controls image forming operation by the image drawer 12.

The memory 16 stores programs executed by the controller 15, setting data used in the program, etc., and data of images formed by the image drawer 12. The memory 16 is a non-volatile storage medium such as an HDD (Hard Disk Drive) and a flash memory. The memory may include a RAM which temporarily stores and processes a part of data.

The communicator 17 controls communication with an external communication device according to a predetermined communication standard. As the communication standard, for example, communication through a LAN (Local Area Network) is used. The communicator 17 includes a network card for controlling communication through the LAN.

The operation interface 18 accepts input operations from the outside such as a user. The operation interface 18 outputs received contents to the controller 15 as an input signal. The operation interface 18 includes a touch panel superimposed on a display screen of the display 19, and a push button switch. The input signal includes push operation of the push button switch, touch operation on the touch panel, and information of a touch position.

The display 19 performs display on a display screen under control of the controller 15. Displayed contents include status of image forming operation and a setting menu to accept input operation from a user. The display screen is, for example, an LCD (liquid crystal display) or an OELD (organic electroluminescence display), but not limited thereto.

### Sheet Distinguisher

Next, configuration of the sheet distinguisher 20 will be described.

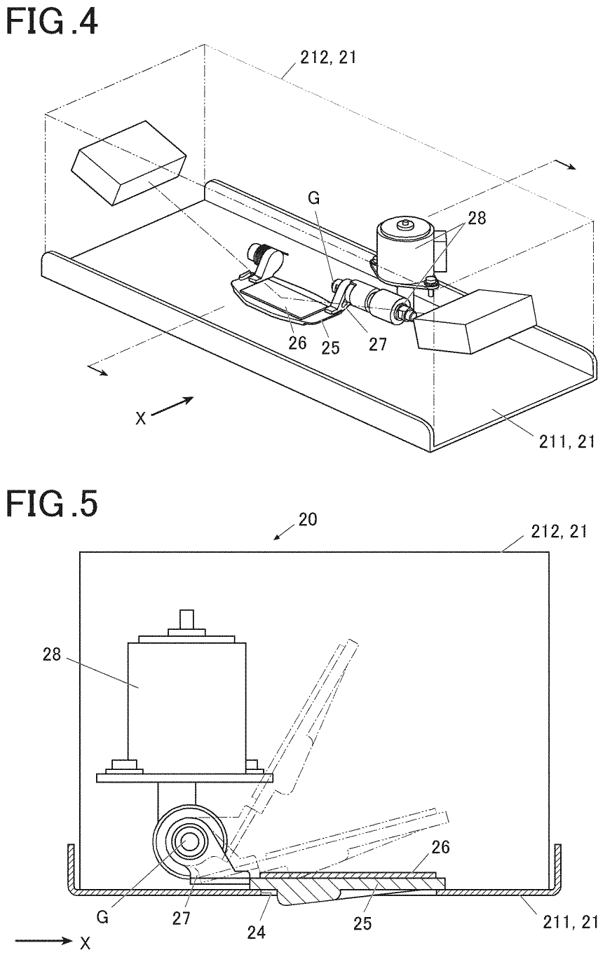

FIG. 3 is a schematic view showing the configuration of the sheet distinguisher 20. FIG. 4 is a schematic perspective view showing a schematic configuration of the sheet distinguisher 20. FIG. 5 is a sectional view along V-V line in FIG. 4.

As shown in FIG. 3 and FIG. 4, the sheet distinguisher 20 includes a housing 21, a light emitter (a measurer) 22, a light receiver (the measurer) 23, an opening 24, a shutter 25, a calibration plate 26, a shutter support 27, and an open-close mechanism 28.

The housing 21 houses the light emitter 22 and the light receiver 23. The opening 24 is formed on the bottom surface of the housing 21.

The light emitter 22 emits light toward a sheet P facing the opening 24. The light receiver 23 receives light reflected from the sheet P.

In the sheet distinguisher 20, the light emitter 22 emits light to the sheet P through the opening 24. The light is reflected from the sheet P and is received by the light receiver 23 through the opening 24. The type of a sheet P is determined based on an amount or the like (detection information) of light which is received by the light receiver 23 after reflected from the sheet P.

Specifically, light reflected from a sheet P is classified into reflected light that is specularly reflected (specularly reflected light) and reflected light that is diffusely reflected (diffuse reflected light).

A type of a sheet P is determined based on an amount of a specific wavelength component in each light component of specularly reflected light and diffuse reflected light. The type may be determined based not on a specific wavelength component but on an amount of received light. Accuracy in distinction is higher in a case of using both the specularly reflected light and diffuse reflected light than in a case of using only one of specularly reflected light and diffuse reflected light.

As shown in FIG. 4 and FIG. 5, the housing 21 is substantially box-shaped. The housing 21 includes a bottom 211 and a lid 212 covering the bottom 211. The opening 24 is provided on the bottom 211. The opening 24 faces the conveyance route R along which sheets P are conveyed.

The housing 21 faces the center of a sheet P conveyed along the conveyance route R. The housing 21 may be movable in accordance with a position of a sheet P in the conveyance route R.

A counter 31 (see FIG. 1) that counts sheets P that has passed through the conveyance route R along the housing 21 is provided in the vicinity of the housing 21 (the measurer).

A thermometer 32 (see FIG. 1) that detects temperature around the housing 21 is provided in the vicinity of the housing 21 (the measurer).

The shutter 25 is attached to the housing 21. The shutter 25 switches between an open state where the opening 24 is open and a closed state where the opening 24 is closed. The shutter 25 is rotatably supported around a rotation shaft G. A portion of the shutter 25 which is downstream from a sheet P in the conveying direction (direction of the arrow X in drawings) is rotatably supported by the shutter support 27.

The shutter 25 switches between the open state and the closed state by being turned by the open-close mechanism 28.

In the open state, the upstream end of the shutter 25 in the conveyance direction (X direction) turns upward in the housing 21.

The shutter 25 switches between two levels of open state under control of the controller 15. In the first open state (dashed line in FIG. 5), the shutter 25 turns by a predetermined angle or more from the bottom 211. In the second open state (two-dot line in FIG. 5), the shutter 25 turns by an angle less than the predetermined angle from the bottom 211.

When the sheet distinguisher 20 determines the type of a sheet P, the shutter 25 is in the first open state and the opening 24 is fully opened.

When the shutter 25 performs open-close operation in calibration information acquisition processing (described later), the shutter 25 is in the second open state.

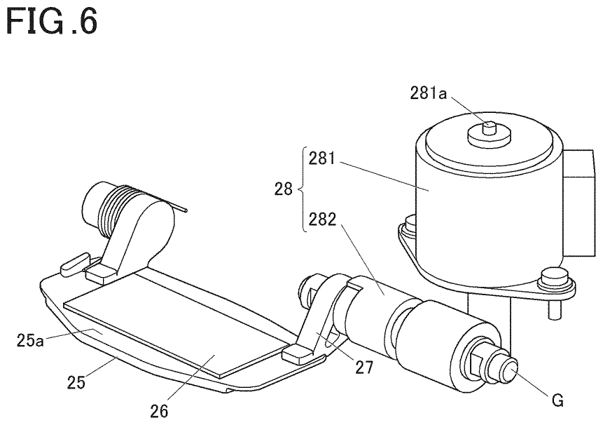

FIG. 6 is a perspective view showing a schematic configuration of the open-close mechanism 28.

As shown in FIG. 6, the open-close mechanism 28 includes a drive 281 and a power transmitter 282.

The drive 281 is, for example, a motor and includes an output shaft 281a. The output shaft 281a is connected to the power transmitter 282. The power transmitter 282 is connected to the shutter support 27. The power transmitter 282 transmits the output (rotational drive power) from the output shaft 281a to the shutter support 27. The shutter support 27 turns around the rotating shaft G. Thereby the shutter 25 is turned.

The calibration plate 26 is disposed on an inner surface 25a of the shutter 25.

The calibration plate 26 calibrates the sheet distinguisher 20. The calibration plate 26 is a plate having predetermined smoothness, such as white resin. The calibration plate 26 is positioned to reflect light emitted from the light emitter 22 toward the light receiver 23 in the closed state of the shutter 25. Condition (amount or the like) of light emitted from the light emitter 22 varies depending on changes over time, environment, etc. Periodic calibration is required. According to the embodiment, the sheet distinguisher 20 is calibrated by adjusting emitting condition or the like based on optical information (acquisition information) of light reflected from the calibration plate 26.

### Operation of Image Forming Apparatus

Next, image forming operation of the image forming apparatus 1 will be described.

When the image forming apparatus 1 forms an image, characteristics of the image vary depending on the type of a sheet P. Characteristics of the image include penetration of colorant into a sheet P, degree of fixation, and degree of spread (blurring). In order to form the optimum image, image forming condition should be adjusted in accordance with the characteristics of a sheet P.

According to the image forming apparatus 1, the sheet distinguisher 20 determines the type of a sheet P before forming an image on the sheet P. The image forming condition is adjusted in accordance with the determined type of the sheet P.

Dirt, aging, environment (e.g., temperature) and the like deteriorate distinction performance of the sheet distinguisher 20. To prevent this, the sheet distinguisher 20 is calibrated.

According to the embodiment, if necessary, calibration information is acquired before the sheet distinguisher 20 acquires the detection information from a sheet P. Calibration using the calibration information maintains high-precision paper distinction performance.

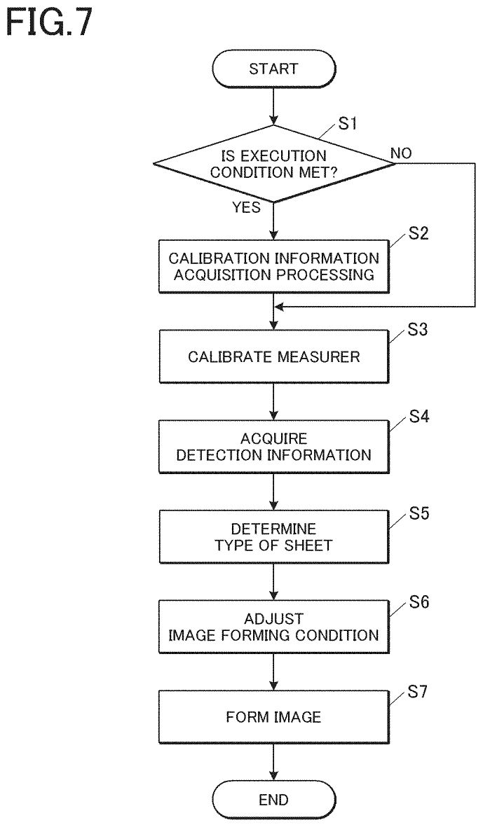

The whole processing will be described with reference to the flowchart in FIG. 7.

According to the image forming apparatus 1, a user inputs an instruction of image forming through the operation interface 18. Then, the controller 15 starts the processing according to programs stored in the memory 16.

First, the controller 15 determines whether a condition for executing processing of acquiring the calibration information is met (Step S1).

One example of the condition is a condition with respect to a count value of the counter 31, that is, whether the number of sheets P having passed through the sheet distinguisher 20 since the last calibration reaches a predetermined value (e.g., about ten to a hundred sheets). Another example of the condition is a condition with respect to temperature detected by the thermometer 32, that is, whether difference in temperature around the sheet distinguisher 20 between now and the last calibration reaches a predetermined value (e.g., 2° C. to 3° C.)

If the condition is not met (Step S1: NO), the controller 15 proceeds to Step S3 described later.

On the other hand, if the condition is met (Step S1: YES), the controller 15 executes the calibration information acquisition processing to obtain the calibration information (Step S2).

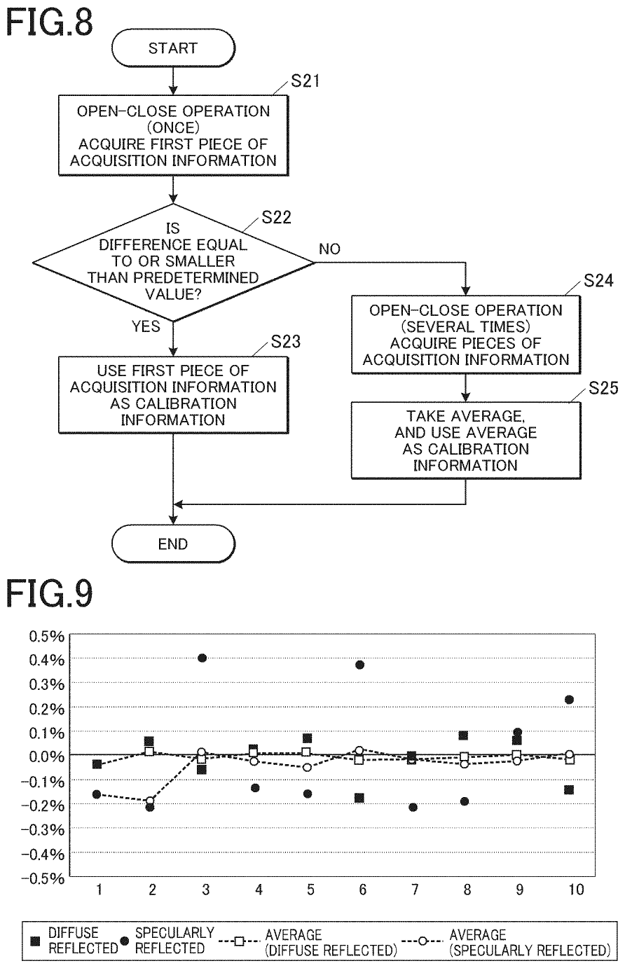

FIG. 8 is a flowchart showing the calibration information acquisition processing.

First, the controller 15 makes the shutter 25 perform open-close operation once. In the closed state after the open-close operation, the controller 15 obtains the acquisition information (a first piece of the acquisition information) from light reflected from the calibration plate 26 (Step S21).

The controller 15 controls the open-close mechanism 28 to make a first rotation angle of the shutter 25 relative to the opening 24 in open-close operation smaller than a second rotation angle of the shutter 25 relative to the opening 24 at which the detection information is acquired. That is, in open-close operation of the shutter 25, the angle at which the shutter 25 is opened in the second open state is smaller than that in the fully open state (the first open state).

It reduces mechanical load and improves time efficiency.

The controller 15 then determines whether difference between the first piece of the acquisition information and a second piece of the acquisition information in the previous (last) calibration is equal to or smaller than a predetermined value (Step S22).

If the difference is equal to or smaller than the predetermined value (Step S22: YES), the controller 15 stores the first piece of the acquisition information as the calibration information (Step S23). Thus the processing ends.

On the other hand, if the difference is larger than the predetermined value (Step S22: NO), the controller 15 makes the shutter 25 further perform open-close operation several times (e.g., nine times). The controller 15 acquires a piece of the acquisition information from light reflected from the calibration plate 26 in each closed state of open-close operation (Step S24). Thus, the controller 15 acquires pieces (in this embodiment, ten pieces) of the acquisition information.

The controller 15 then takes an average of the pieces of the acquisition information and stores the average as the calibration information (Step S25). Thus the processing ends.

FIG. 9 shows acquired pieces of the acquisition information and fluctuations of an average.

In FIG. 9, the vertical axis indicates the value of the acquisition information. The horizontal axis indicates the number of times of open-close operation.

In FIG. 9, the acquisition information of specularly reflected light is indicated by a black circle and an average of the acquisition information is indicated by a white circle. The acquisition information of diffuse reflected light is indicated by a black square and an average of the acquisition information is indicated by a white square.

FIG. 9 shows that values of specularly reflected light vary widely depending on open-close operation (see fluctuations of black circle) and that averaging reduces variation (see fluctuations of white circle).

FIG. 9 shows that values of diffuse reflected light do not vary significantly depending on open-close operation (see fluctuations of the black square). Therefore, an average of values of only specularly reflected light may be taken.

Next, as shown in FIG. 7, the controller 15 calibrates the measurer of the sheet distinguisher 20 by adjusting emitting condition or the like using the calibration information (Step S3). The controller 15 then conveys a sheet P. The sheet distinguisher 20 acquires the detection information from light reflected from a sheet P (Step S4).

The controller 15 then determines the type of the sheet P from the detection information (Step S5). The controller 15 adjusts the image forming condition according to the type of the sheet P (Step S6) and forms an image on the sheet P (Step S7). Thus the processing ends.

### Advantageous Effect of Embodiment

As described above, the sheet distinction device according to the embodiment includes:
the shutter 25 that switches between the open state and the closed state of the opening 24;
the calibration plate 26 provided on the surface of the shutter 25 which is on the inner side in the closed state;
the open-close mechanism 28 that opens and closes the shutter 25; and
the controller 15 that controls the open-close mechanism 28 to make the shutter 25 perform open-close operation in which the shutter 25 switches between the open state and the closed state continuously.

In the closed state during open-close operation, the controller 15 makes the measurer (the light emitter 22 and the light receiver 23) emit light toward the calibration plate 26 and receive the reflected light to acquire the acquisition information, and calibrates the measurer based on the acquisition information.

The device maintains high-precision paper distinction performance by constantly and appropriately performing calibration while reducing effect of dust.

According to the embodiment, the controller 15 acquires the first piece of the acquisition information by making the shutter 25 perform open-close operation once. If the difference between the first piece of the acquisition information and the second piece of the acquisition information used in the previous calibration is equal to or smaller than a predetermined value, the controller 15 calibrates the measurer based on the first piece of the acquisition information.

Therefore, in a case in which it is determined that the calibration information has not changed significantly, the calibration information is not acquired. This reduces mechanical load caused by open-close operation.

According to the embodiment, if the difference is larger than a predetermined value, the controller 15 makes the shutter 25 perform open-close operation several times. The controller 15 acquires a piece of the acquisition information in each closed state during open-close operation, and calibrates the measurer based on an average of pieces of the acquisition information.

This minimizes variation in pieces of the acquisition information due to open-close operation of the shutter 25. It maintains high-precision paper distinction performance.

According to the embodiment, the measurer receives, as reflected light, specularly reflected light and diffuse reflected light. The controller 15 takes an average of at least specularly reflected light.

This minimizes effect of at least specularly reflected light, which is significantly affected by open-close operation of the shutter 25.

According to the embodiment, the open-close mechanism 28 turns the shutter 25. The controller 15 controls the open-close mechanism 28 to make the first rotation angle of the shutter 25 relative to the opening 24 in open-close operation smaller than the second rotation angle of the shutter 25 relative to the opening 24 when detection information is acquired.

This reduces mechanical load caused by open-close operation. Decrease in productivity is avoided.

According to the embodiment, the open-close mechanism 28 turns the shutter 25. The controller 15 controls the open-close mechanism 28 to press the shutter 25 against the periphery of the opening 24 in the closed state, where the acquisition information is acquired.

This reduces mechanical vibration as much as possible. The more accurate acquisition information is acquired.

According to the embodiment, the controller 15 includes the thermometer that detects temperature around the measurer. If difference between a first temperature detected by the thermometer and a second temperature around the measurer detected for the last calibration is equal to or larger than a predetermined value, the controller 15 acquires the calibration information.

In a case in which it is determined that the calibration information has not been changed by environment, the calibration information is not acquired. This reduces mechanical load caused by open-close operation.

According to the embodiment, the device includes the counter that counts sheets that has passed through the conveyance route of sheets along the measurer. If the number counted by the counter since the last calibration reaches a predetermined value, the controller 15 acquires the calibration information.

In a case in which it is determined that the calibration information has not changed through aging, the calibration information is not acquired. This reduces mechanical load caused by open-close operation.

According to the embodiment, the housing 21 faces the center of a sheet P conveyed along the conveyance route.

Thus, more accurate information is acquired.

Specific details such as configuration, construction, control contents and order in the embodiment can be changed within the scope of the present invention.

In the embodiment, the open-close mechanism 28 turns the shutter 25. However, for example, the open-close mechanism 28 may slide the shutter 25 for opening and closing.

In the embodiment, the image forming apparatus of the electrophotographic method is exemplified. However, the image forming apparatus may use other image forming methods, such as an ink jet method in which an image is formed by discharging ink to a sheet P.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2019-094258, filed on May 20, 2019, is incorporated herein by reference in its entirety.

What is claimed is:

1. A sheet distinction device, comprising:
a measurer that emits light to a sheet, receives light reflected from the sheet, and acquires detection information for determining physical properties of the sheet;
a housing that houses the measurer and is provided with an opening through which the emitted light and the reflected light pass;
a shutter that switches between a closed state in which the opening is closed and an open state in which the opening is open;
a calibration plate provided on a surface of the shutter which is on an inner side in the closed state;
an open-close mechanism that opens and closes the shutter; and
a controller that controls the open-close mechanism to make the shutter perform open-close operation in which the shutter switches between the open state and the closed state continuously,
wherein
in the closed state during the open-close operation, the controller makes the measurer emit light to a calibration plate and receive reflected light to acquire acquisition information, and
the controller calibrates the measurer based on the acquisition information.

2. The sheet distinction device according to claim 1, wherein
the controller makes the shutter perform the open-close operation once to acquire a first piece of the acquisition information, and
if difference between the first piece of the acquisition information and a second piece of the acquisition information used in previous calibration for the measurer is equal to or less than a predetermined value, the controller calibrates the measurer based on the first piece of the acquisition information.

3. The sheet distinction device according to claim 2, wherein, if the difference is larger than the predetermined value, the controller (i) makes the shutter perform the open-close operation a plurality of times, (ii) acquires a piece of the acquisition information in each closed state during the open-close operation, and (iii) calibrates the measurer based on an average of pieces of the acquisition information.

4. The sheet distinction device according to claim 3, wherein
the measurer receives, as the reflected light, specularly reflected light and diffuse reflected light, and
the controller takes an average of at least the specularly reflected light.

5. The sheet distinction device according to claim 1, wherein
the open-close mechanism turns the shutter,
the controller controls the open-close mechanism to make a first rotation angle of the shutter relative to the opening in the open-close operation smaller than a second rotation angle of the shutter relative to the opening when the detection information is acquired.

6. The sheet distinction device according to claim 1, wherein
the open-close mechanism turns the shutter.
the controller controls the open-close mechanism to press the shutter against a periphery of the opening in the closed state in which the acquisition information is acquired.

7. The sheet distinction device according to claim 1, further comprising:
a thermometer that detects temperature around the measurer,
wherein, if difference between a first temperature detected by the thermometer and a second temperature around the measurer detected for the last calibration of the measurer is equal to or larger than a predetermined value, the controller acquires the acquisition information.

8. The sheet distinction device according to claim 1, further comprising:
a counter that counts sheets that has passed through a conveyance route of the sheets along the measurer,
wherein, if the number counted by the counter since the last calibration of the measurer is equal to or larger than a predetermined value, the controller acquires the acquisition information.

9. The sheet distinction device according to claim 1, wherein the housing faces a center of a sheet conveyed along the conveyance route.

10. An image forming apparatus comprising the sheet distinction device according to claim 1.
